(19) United States
(12) Patent Application Publication
(10) Pub. No.: US 2025/0171018 A1
(43) Pub. Date: May 29, 2025

(54) DEVICE AND METHOD WITH HYPERPARAMETER DETERMINATION

(71) Applicant: Samsung Electronics Co., Ltd., Suwon-si (KR)

(72) Inventors: Joonwoo AHN, Suwon-si (KR); Jahoo KOO, Suwon-si (KR); Seho SHIN, Suwon-si (KR)

(73) Assignee: Samsung Electronics Co., Ltd., Suwon-si (KR)

(21) Appl. No.: 18/772,565

(22) Filed: Jul. 15, 2024

(30) Foreign Application Priority Data
Nov. 24, 2023 (KR) 10-2023-0165632

(51) Int. Cl. B60W 30/095; B60W 30/09

(52) U.S. Cl. CPC B60W 30/0956; B60W 30/09

(57) ABSTRACT

A processor-implemented method includes generating a plurality of trajectories for a driving situation of the moving object based on either one or both of a speed and a steering of the moving object, selecting candidate trajectories based on a presence of an obstacle among the plurality of trajectories, outputting hyperparameters related to driving of the moving object by inputting data related to the driving situation to a machine learning model, selecting a target trajectory from the candidate trajectories based on the hyperparameters, and controlling the steering and the speed such that the moving object moves along the target trajectory, wherein the hyperparameters comprise a first hyperparameter for the speed of the moving object, a second hyperparameter for a degree to which the moving object is able to avoid an obstacle, and a third hyperparameter for a global path to a destination, and wherein the hyperparameters vary while the moving object travels.

### CROSS-REFERENCE TO RELATED APPLICATIONS

This application claims the benefit under 35 USC § 119(a) of Korean Patent Application No. 10-2023-0165632, filed on Nov. 24, 2023 in the Korean Intellectual Property Office, the entire disclosure of which is incorporated herein by reference for all purposes.

### BACKGROUND

### 1. Field

The following description relates to a device and method with hyperparameter determination.

### 2. Description of Related Art

A process in which a moving object such as a vehicle or a mobile robot reaches a destination from a starting point may be referred to as navigation. Also, when the moving object performs this process by itself, the process may be referred to as autonomous navigation or autonomous driving. The autonomous driving may be performed by repeating a recognition process, a positioning process, and a motion planning process. The recognition process may be a process of distinguishing a drivable area or an undrivable area using an input of a camera and a light detection and ranging (lidar) sensor. The positioning process may be a process of identifying a direction and a location of a moving object on a map including a starting point and a destination. The motion planning process may be a process of obtaining a path to reach a destination by avoiding obstacles and a control input to follow the path, through the recognition process and the positioning process.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating a plurality of trajectories for a driving situation of the moving object based on either one or both of a speed and a steering of the moving object, selecting candidate trajectories based on a presence of an obstacle among the plurality of trajectories, outputting hyperparameters related to driving of the moving object by inputting data related to the driving situation to a machine learning model, selecting a target trajectory from the candidate trajectories based on the hyperparameters, and controlling the steering and the speed such that the moving object moves along the target trajectory, wherein the hyperparameters may include a first hyperparameter for the speed of the moving object, a second hyperparameter for a degree to which the moving object is able to avoid an obstacle, and a third hyperparameter for a global path to a destination, and wherein the hyperparameters vary while the moving object travels.

The selecting of the candidate trajectories may include selecting the candidate trajectories using remaining trajectories excluding trajectories in which the presence of an obstacle is determined within a threshold radius around the moving object, from the plurality of trajectories.

The selecting of the target trajectory from the candidate trajectories may include determining a score for each of the candidate trajectories using the hyperparameters, and selecting a candidate trajectory having a highest score as the target trajectory.

The machine learning model may be a model trained through reinforcement training according to a reward determined based on a first factor for the speed of the moving object, a second factor for a degree to which the moving object is able to avoid an obstacle, and a third factor for a distance between the moving object and the destination.

In response to the driving situation being a driving situation in which an obstacle is not present within a front threshold distance of the moving object and a curvature of a driving lane, on which the moving object travels, being within a threshold curvature, the first hyperparameter may be determined to be greatest among the hyperparameters.

In response to the driving situation being a driving situation in which an obstacle is present within a front threshold distance of the moving object and a curvature of a driving lane, on which the moving object travels, exceeding a threshold curvature, the second hyperparameter may be determined to be greatest among the hyperparameters.

In response to the driving situation being a situation in which the moving object travels on a driving lane comprising two or more branches, the third hyperparameter may be determined to be greatest among the hyperparameters.

In response to a density of obstacles increasing with respect to an empty space around a driving lane, on which the moving object travels, the second hyperparameter may be determined to increase.

In one or more general aspects, a non-transitory computer-readable storage medium may store instructions that, when executed by one or more processors, configure the one or more processors to perform any one, any combination, or all of operations and/or methods disclosed herein.

In one or more general aspects, a processor-implemented method includes selecting candidate trajectories based on a presence of an obstacle among a plurality of trajectories generated for a driving situation of the moving object based on either one or both of a speed and a steering of the moving object, outputting hyperparameters related to driving of the moving object by inputting data related to the driving situation to a machine learning model, selecting a target trajectory from the candidate trajectories based on the hyperparameters, and controlling the steering and the speed such that the moving object moves along the target trajectory, wherein the machine learning model is a model trained through reinforcement training according to a reward determined based on a first factor for the speed of the moving object, a second factor for a degree to which the moving object is able to avoid an obstacle, and a third factor for a distance between the moving object and the destination, and wherein the hyperparameters vary while the moving object travels.

The hyperparameters may include a first hyperparameter for the speed of the moving object, a second hyperparameter for the degree to which the moving object is able to avoid an obstacle, and a third hyperparameter for a global path to a destination.

In one or more general aspects, an electronic device includes one or more processors configured to generate a plurality of trajectories for a driving situation of a moving object based on either one or both of a speed and a steering of the moving object, select candidate trajectories based on a presence of an obstacle among the plurality of trajectories, output hyperparameters related to driving of the moving object by inputting data related to the driving situation to a machine learning model, select a target trajectory from the candidate trajectories based on the hyperparameters, and control the steering and the speed such that the moving object moves along the target trajectory, and wherein the hyperparameters may include a first hyperparameter for the speed of the moving object, a second hyperparameter for a degree to which the moving object is able to avoid an obstacle, and a third hyperparameter for a global path to a destination, and wherein the hyperparameters vary while the moving object travels.

For the selecting of the candidate trajectories, the one or more processors may be configured to select the candidate trajectories using remaining trajectories excluding trajectories in which the presence of an obstacle may be determined within a threshold radius around the moving object, from the plurality of trajectories.

For the selecting of the target trajectory, the one or more processors may be configured to determine a score for each of the candidate trajectories using the hyperparameters, and select a candidate trajectory having a highest score as the target trajectory.

The machine learning model may be a model trained through reinforcement training according to a reward determined based on a first factor for the speed of the moving object, a second factor for a degree to which the moving object is able to avoid an obstacle, and a third factor for a distance between the moving object and the destination.

In response to the driving situation being a driving situation in which an obstacle is not present within a front threshold distance of the moving object and a curvature of a driving lane, on which the moving object travels, being within a threshold curvature, the first hyperparameter may be determined to be greatest among the hyperparameters.

In response to the driving situation being a driving situation in which an obstacle is present within a front threshold distance of the moving object and a curvature of a driving lane, on which the moving object travels, exceeding a threshold curvature, the second hyperparameter may be determined to be greatest among the hyperparameters.

In response to the driving situation being a situation in which the moving object travels on a driving lane comprising two or more branches, the third hyperparameter may be determined to be greatest among the hyperparameters.

In response to a density of obstacles increasing with respect to an empty space around a driving lane, on which the moving object travels, the second hyperparameter may be determined to increase.

In one or more general aspects, a processor-implemented method includes selecting candidate trajectories based on a presence of an obstacle among a plurality of trajectories generated for a driving situation of a moving object based on either one or both of a speed and a steering of the moving object, using a machine learning model, adjusting hyperparameters based on whether an obstacle is present within a front threshold distance of the moving object and whether a curvature of a path on which the moving object travels is within a threshold curvature, and determining a score for each of the candidate trajectories using the hyperparameters, and

determining a target trajectory by selecting a candidate trajectory having a highest score among the scores.

Other features and aspects will be apparent from the following detailed description, the drawings, and the claims.

### BRIEF DESCRIPTION OF THE DRAWINGS

FIG. 1 illustrates an example of an electronic device.

FIG. 2 schematically illustrates an example of motion planning.

FIG. 3 illustrates an example of an operating method of a moving object.

FIG. 4 illustrates an example of training a machine learning model.

FIGS. 5 to 7 illustrate examples of driving situations.

FIG. 8 illustrates an example of a moving object.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on”, “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, should be construed to have meanings matching with contextual meanings in the relevant art and the disclosure of the present application, and are not to be construed to have an ideal or excessively formal meaning unless otherwise defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Hereinafter, the examples will be described in detail with reference to the accompanying drawings. When describing the examples with reference to the accompanying drawings, like reference numerals refer to like elements and a repeated description related thereto will be omitted.

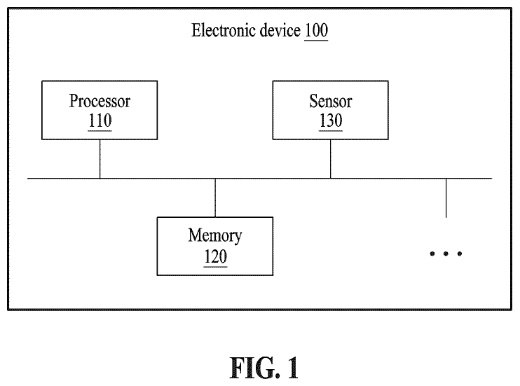

FIG. 1 illustrates an example of an electronic device.

Referring to FIG. 1, an electronic device 100 may include a processor 110 (e.g., one or more processors), a memory 120 (e.g., one or more memories), and a sensor 130 (e.g., one or more sensors). The processor 110 and the memory 120 may communicate with each other through a bus, a network on a chip (NoC), peripheral component interconnect express (PCIe), and/or the like. The electronic device 100 herein may be a moving object. For example, the electronic device 100 may be a moving object corresponding to any device, such as a vehicle, a mobile robot, or a drone, that may autonomously drive by recognizing a surrounding environment using the sensor 130 including a camera and/or a sensor (e.g., light detection and ranging (lidar)). The processor 110 may perform overall functions for controlling the electronic device 100.

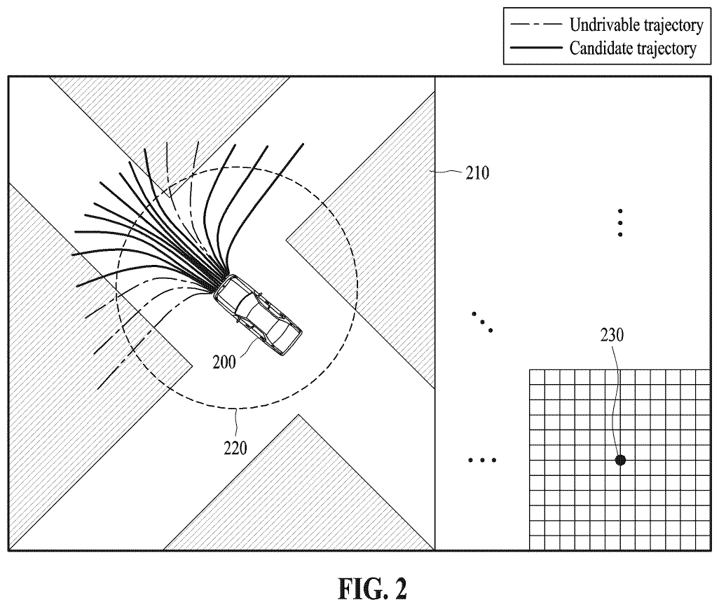

The processor 110 may control the electronic device 100 overall by executing programs and/or instructions stored in the memory 120. The processor 110 may be implemented as a central processing unit (CPU), a graphics processing unit (GPU), an application processor (AP), and the like, that are included in the electronic device 100, however, examples are not limited thereto. For example, the processor 110 may cause the electronic device 100 to perform operations shown in FIGS. 2 to 8 by executing the programs and/or instructions stored in the memory 120.

The memory 120 may be hardware for storing data processed in the electronic device 100 and data to be processed. In addition, the memory 120 may store an application, a driver, and the like to be driven by the electronic device 100. In addition, the memory 120 may store instructions and/or programs that may be executed by the processor 110. For example, the memory 120 may include a non-transitory computer-readable storage medium storing instructions that, when executed by the processor 110, configure the processor 110 to perform any one, any combination, or all of operations and/or methods disclosed herein with reference to FIGS. 1-8. The memory 120 may include a volatile memory (e.g., dynamic random access memory (DRAM)) and/or a nonvolatile memory.

The sensor 130 may include a plurality of sensors including one or more cameras and one or more lidar sensors.

In the example of FIG. 1, only the components related to the example described herein are illustrated as being included in the electronic device 100. Thus, the electronic device 100 may also include other general-purpose components, in addition to the components illustrated in FIG. 1. Although not shown in FIG. 1, the electronic device 100, for example, may further include other devices, such as an input device, an output device, and a network device for autonomous driving.

The present disclosure may relate to motion planning. The motion planning may be divided into a model-based method and a learning-based method. A model-based motion planning method may be a method of obtaining an optimal control input value depending on situations by modeling an objective function and a restriction condition for humans to perform an object. A learning model-based motion planning method may be a method of controlling steering and a speed of a moving object by collecting data obtained by the moving object through driving and inputting data related to the driving to a learning model trained with a neural network.

In a typical model-based motion planning method, the following problems may occur because it may be difficult for the typical model-based motion planning method to determine an optimal hyperparameter included in an objective function.

First, human labor may be required repeatedly to tune hyperparameters. In the typical model-based motion planning method, it may be necessary for humans to tune hyperparameters through trial and error while performing an autonomous driving test. For example, it may be necessary to set suitable hyperparameters for various driving situations, evaluate driving performance through heuristic determination, and repeat an operation of setting other hyperparameters and evaluating performance again when the driving performance is not suitable. Thus, a large amount of labor may be required to implement the typical model-based motion planning method.

Second, accurate tuning may not be performed because the evaluation of the driving performance is performed by human. For example, accurate tuning may not be performed through non-quantitative heuristic determination. There may be differences in driving performance depending on a hyperparameter ratio that determines a weight between items present in the objective function, and since an optimal hyperparameter may differ depending on the driving situation, accurate tuning may not be performed based on heuristic determination. For example, when a weight for an item for performing rapid driving is high, there may be insufficient consideration for an item for easily avoiding an obstacle and an item for closely following a global path. Also, for example, in a driving situation where an obstacle is to be avoided while closely following a global path (e.g., a situation where the item for easily avoiding an obstacle and the item for closely following a global path are in conflict), the tuning may not be performed accurately by heuristic determination.

The learning model-based motion planning method may only consider situations included in training data without the need for hyperparameter tuning. However, due to a disadvantage that performance may vary greatly depending on the training data, the following two problems may occur in a typical learning model-based motion planning method.

First, the typical learning model-based motion planning method may show a driving result with a high risk for a situation not included in the training data. A result output from a deep neural network may lack certainty, and this may be a serious disadvantage in autonomous driving in which safety needs to be considered important.

Second, in order to reduce the risk associated with the problem described above, a large amount of training data for various situations may be required. For example, when an imitation learning method is used, training data may be obtained during a process in which human drives. Thus, a large amount of human labor may be required to obtain sufficient training data. For example, in a reinforcement learning method, data may be obtained through trial and error, and countless hours of training time may be required to handle a complicated driving situation while satisfying all of the item for performing rapid driving, the item for easily avoiding an obstacle, and the item for following a global path.

Hereinafter, a method of one or more embodiments of determining a hyperparameter that offsets the disadvantages of the typical learning model-based motion planning method and the typical model-based motion planning method with the advantages of the learning model-based motion planning method and the model-based motion planning method, respectively, will be described.

FIG. 2 schematically illustrates an example of motion planning.

A mobile object 200 (e.g., the electronic device 100 of FIG. 1) may generate an occupancy grid map 210 by dividing a surrounding environment of the moving object 200 into roads, lanes, vehicles, and curbs using sensor inputs obtained from a plurality of sensors (e.g., the sensor 130 of FIG. 1). In the occupancy grid map 210, a dark portion may be an undrivable area, and a bright portion may be a drivable area. The undrivable area may be determined as an obstacle.

The moving object 200 may generate positioning information, which may include location and direction information about a moving object with respect to a stored map using the global positioning system (GPS) and simultaneous localization and mapping (SLAM). For example, a moving object 200 may generate the positioning information including location and direction information about the moving object 200 based on an origin 230 of a map. The positioning information may be expressed as (x, y, yaw). Specifically, the positioning information may include location information (e.g., (x, y)) of the moving object 200 based on the origin 230, and direction information (e.g., yaw) indicating a direction in which the moving object 200 faces based on the origin 230.

The moving object 200 may generate a global plan which is a result of determining which direction the moving object 200 is to move in on a branching road such as an intersection or a corner existing in a path from a starting point to a destination. According to an example, the global plan may include either one or both of a shortest distance plan to reach a destination from a starting point and a plan to take a minimum amount of time to reach the destination from the starting point, that is to be provided by a navigation application. According to an example, the global plan may be determined using a rural postman problem (RPP) method.

The occupancy grid map 210, the positioning information, and the global plan may be data related to a driving situation. The moving object 200 may perform motion planning by inputting the data related to the driving situation. The moving object 200 may calculate (e.g., determine) steering and a speed for the moving object 200 based on the data related to the driving situation. For this, a target trajectory to be followed by the moving object 200 may be selected.

The moving object 200 may generate a plurality of trajectories for a driving situation based on the speed and/or the steering of the moving object 200. According to an example, the moving object 200 may generate the plurality of trajectories using a tentacle algorithm. The driving situation may refer to a situation currently faced by the moving object 200 which moves to reach a destination. For example, the driving situation may refer to various situations currently faced by the moving object 200 to reach a destination based on a current location of the moving object 200. For example, referring to FIG. 2, the driving situation may be a branching road currently faced by the moving object 200. However, the driving situation may also refer to various situations that may be faced by the moving object 200 to reach a destination, such as a situation in which the moving object 200 is to pass through a narrow path, a situation in which the moving object 200 is to avoid an obstacle, and a situation in which the moving object 200 is to move along a straight road without obstacles.

The moving object 200 may select candidate trajectories from the plurality of trajectories based on a distance from an obstacle. The obstacle may be a dark area on the occupancy grid map 210. The moving object 200 may determine trajectories in which an obstacle exists within a circle 220 with a threshold radius around the moving object as undrivable trajectories. The threshold radius may be changed according to the driving situation. According to an example, the threshold radius may be changed according to the driving situation by a learning model, such as hyperparameters to be described below.

The moving object 200 may calculate scores for candidate trajectories, and determine a trajectory having a highest score as a target trajectory. An objective function for calculating the score may be quantified through three items. Each item may have the same ratio through normalization. The objective function for calculating the score may include a first item for a movement speed of the moving object, a second item for obstacle avoidance performance of the moving object, and a third item for global plan following by the moving object. A high value of each item may imply that the performance is excellent. For example, a speed of the moving object that moves along a candidate trajectory having a higher valued first item may be faster than a speed of the moving object that moves along a candidate trajectory having a lower valued first item. The moving object that moves along a candidate trajectory having a higher valued second item may avoid an obstacle in a more excellent manner (e.g., may pass the object at a greater distance) than the moving object that moves along a candidate trajectory having a lower valued second item. The moving object that moves along a candidate trajectory having a higher valued third item may follow a global plan in a more excellent manner (e.g., reaches a destination from a starting point in a shorter distance and/or takes less time to reach the destination from the starting point) than the moving object that moves along a candidate trajectory having a lower valued third item.

Each item may be adjusted by hyperparameters. The first item may be adjusted by a first hyperparameter for the speed of the moving object. The second item may be adjusted by a second hyperparameter for the extent to which the moving object may avoid an obstacle. The third item may be adjusted by a third hyperparameter for a global path to a destination.

When the target trajectory is determined, the moving object 200 may calculate target steering and a target speed to move along the determined target trajectory. For example, the moving object 200 may calculate the target steering and the target speed in consideration of a curvature and a length of the target trajectory. The moving object 200 may control current steering and a current speed to reach the target steering and the target speed.

In the typical model-based motion planning method, there may be a problem that a person needs to manually tune the hyperparameters described above by finding an appropriate value one by one through driving. In the typical learning model-based motion planning method, the speed and the steering are controlled according to the situation included in the training data without tuning of the hyperparameters described above, and thus, there may be a problem that the performance varies depending on the training data.

Therefore, to solve such technical problems of the typical model-based motion planning method and the typical learning model-based motion planning method, hereinafter, a method of one or more embodiments of determining the hyperparameters described above using a machine learning model will be described.

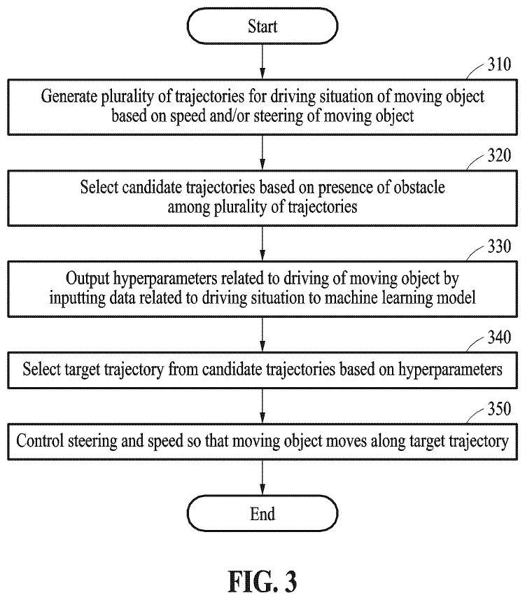

FIG. 3 illustrates an example of an operating method of a moving object.

In the following examples, operations may be performed sequentially, but not necessarily performed sequentially. For example, the order of the operations may be changed and at least two of the operations may be performed in parallel. Operations shown in FIG. 3 may be performed by at least one component of an electronic device (e.g., the electronic device 100 of FIG. 1).

In operation 310, a moving object may generate a plurality of trajectories for a driving situation of the moving object based on a speed and/or steering of the moving object. The plurality of trajectories may be determined differently according to a current speed and/or steering of the moving object. For example, when the current speed of the moving object is high, curvatures of the plurality of trajectories may be determined to be small. For example, when the current steering of the moving object faces a right side, a curvature of a trajectory for a right turn among the plurality of trajectories may be greater than a curvature of a trajectory for a left turn.

In operation 320, the moving object may select candidate trajectories based on the presence of an obstacle among the plurality of trajectories.

The moving object may exclude trajectories in which the presence of an obstacle is determined within a threshold radius around the moving object, from the plurality of trajectories. For example, the moving object may exclude undrivable trajectories from the plurality of trajectories. Remaining trajectories excluding the undrivable trajectories from the plurality of trajectories may be determined as the candidate trajectories. According to an example, the threshold radius is a hyperparameter and may be changed according to a driving situation of the moving object by a machine learning model described in the disclosure.

In operation 330, the moving object may output hyperparameters related to the driving of the moving object by inputting data related to the driving situation to the machine learning model.

The data related to the driving situation may include an occupancy grid map, positioning information, and a global plan.

The hyperparameters may include a first hyperparameter for a speed of the moving object, a second hyperparameter for a degree to which the moving object may avoid an obstacle, and a third hyperparameter for a global path to a destination. When the driving situation changes, the pieces of data related to the driving situation may also change. Accordingly, the hyperparameters may be changed according to the driving situation.

The machine learning model may be a model trained to output a hyperparameter to cause the moving object to determine an optimal trajectory based on the driving situation of the moving object.

In operation 340, the moving object may select a target trajectory from the candidate trajectories based on the hyperparameters.

The target trajectory may be an optimal trajectory. The moving object may calculate a score for each of the candidate trajectories, and determine a candidate trajectory having a highest score as the target trajectory. According to an example, the moving object may calculate the scores of the candidate trajectories by Equation 1 below, for example. However, Equation 1 is merely an example, and the moving object may calculate the scores of the candidate trajectories using various methods.

$$S = {α}_{0} {V}_{0} + {α}_{1} {V}_{1} + {α}_{2} {V}_{2} \qquad Equation 1$$

In Equation 1, S may be a score of a candidate trajectory, α₀ may be a first hyperparameter for a speed of a moving object, α₁ may be a second hyperparameter for a degree to which a moving object may avoid an obstacle, and α₂ may be a third hyperparameter for a global path to a destination. In this example, α₀+α₁+α₂=1 may be satisfied, and α₀, α₁, and α₂ may be greater than or equal to 0. V₀ is a value for a length of the candidate trajectory, and may be a normalized value for all candidate trajectories. V₁ is an inverse of the value of a density of obstacles existing around the candidate trajectory, and may be a normalized value for all candidate trajectories. V₂ is a value of a degree to which the candidate trajectory follows the global path, and may be a normalized value for all candidate trajectories.

The moving object may calculate a score for each candidate trajectory by Equation 1. The moving object may select a candidate trajectory having a highest score as the target trajectory.

In operation 350, the moving object may control the steering and the speed so that the moving object moves along the target trajectory.

The moving object may control the steering and the speed based on the hyperparameters so that the moving object may move along the target trajectory.

As a result, the method of one or more embodiments may change the determined hyperparameters according to the driving situation, thereby enabling more stable driving, unlike the typical model-based motion planning method that does not change the hyperparameters once the hyperparameters are determined. Also, the method of one or more embodiments may output hyperparameters appropriate for the driving situation, thereby enabling more stable driving, unlike the typical learning model-based motion planning method that may show a driving result with a high risk in a situation not included in training data without tuning hyperparameters.

Hereinafter, the training of the machine learning model for outputting the hyperparameters will be described.

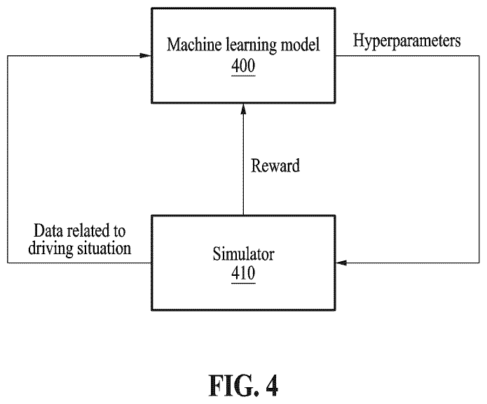

FIG. 4 illustrates an example of training a machine learning model.

A simulator 410 may be used to train a machine learning model 400 for outputting hyperparameters. The simulator 410 may include a moving object, a road, obstacles (e.g., other moving objects), a map, and the like.

FIG. 4 shows the machine learning model 400. The machine learning model 400 may include a convolutional neural network (CNN) configured to effectively process a two-dimensional (2D) input. The machine learning model 400 may receive data related to a driving situation from the simulator 410. The data related to the driving situation may include an occupancy grid map, positioning information, and a global plan. All pieces of the data related to the driving situation may be converted into the 2D form before being input to the machine learning model 400.

The machine learning model 400 may receive the data related to the driving situation and output hyperparameters. The hyperparameters may include the first hyperparameter, the second hyperparameter, and the third hyperparameter described above. The simulator 410 may perform a simulation for the moving object by applying the hyperparameters. The simulator 410 may determine a reward to be given to the machine learning model 400 based on a simulation result. The machine learning model 400 may receive the reward from the simulator 410 during a training process. The machine learning model 400 may be trained to obtain a greater reward through reinforcement learning. For example, the machine learning model 400 may be updated to obtain a greater reward.

The reward may be determined based on a first factor for a speed of a moving object, a second factor for a degree to which the moving object may avoid an obstacle, and a third factor for a distance between the moving object and a destination. The reward may be modeled in a variety of ways.

The reward may be modeled to be similar to an objective function. For example, each factor in the reward may correspond to each item of the objective function used when selecting a target trajectory. For example, the first factor for the speed of the moving object may correspond to the first item for a movement speed of the moving object. The second factor for the degree to which the moving object may avoid an obstacle may correspond to the second item for the obstacle avoidance performance of the moving object. The third factor for the distance from the moving object to the destination may correspond to the third item for global plan following by the moving object.

The first factor relates to the speed of the moving object and may be proportional to the speed of the moving object. For example, as the moving object moves fast in the simulation, the first factor may be determined to be higher. However, the second factor relates to the degree to which the moving object may avoid an obstacle, and may relate to a collision of the moving object. In the autonomous driving, the moving object needs to reach a destination without a collision with an obstacle. Therefore, as the moving object collides with obstacles more times in the simulation, the reward may become smaller. Thus, the second factor may be negative, and an absolute value of the second factor may be determined to be higher, as the moving object collides with obstacles more. The third factor relates to the distance between the moving object and the destination, and may be determined to be higher as the moving object follows a global path at a branching road such as an intersection. For example, when the moving object has turned left at an intersection where a right turn is required according to the global path, the third factor may be determined to be low.

According to an example, the reward may be determined by the sum of the first factor, the second factor, and the third factor. Thus, since the second factor is negative, the reward may be determined as a positive number, zero, or a negative number. For example, when the absolute value of the second factor is greater than the sum of the first factor and the third factor, the reward may be determined as a negative number.

When the reward is a positive number, the machine learning model 400 may be updated to obtain a higher reward. According to an example, not colliding with an obstacle may be most important in the autonomous driving. Accordingly, the rewarded machine learning model 400 may be trained to optimize the second hyperparameter first. For example, the second hyperparameter may be trained by applying more weight to the second hyperparameter compared to other hyperparameters. In the autonomous driving, following a global path may be important after not colliding with an obstacle. Thus, the rewarded machine learning model 400 may be trained by applying more weight to the third hyperparameter after the second hyperparameter, compared to the first hyperparameter.

Hereinafter, an output of the machine learning model 400 that has been trained in various driving situations will be described.

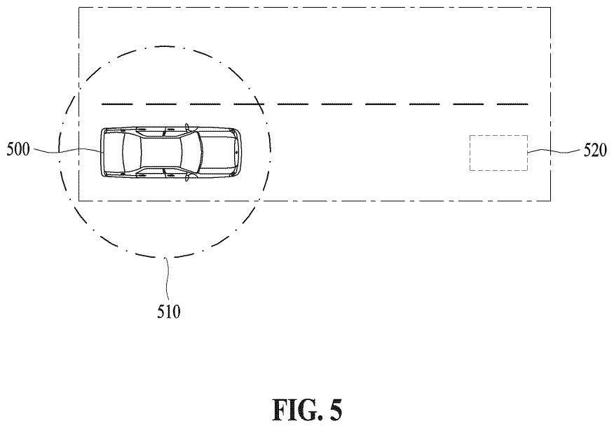

FIGS. 5 to 7 illustrate examples of driving situations.

FIG. 5 shows a moving object 500 traveling on a straight road. It is assumed that the moving object 500 includes a machine learning model that has been trained to output optimal hyperparameters. In the disclosure, a driving lane may refer to a lane or path on which a moving object travels.

At this time, the driving situation of the moving object 500 may be a situation in which a curvature of the driving lane, on which the moving object travels, is less than or equal to a threshold curvature, and an obstacle is not present within a front threshold distance of the moving object. For example, the driving situation of the moving object 500 may be a situation in which the moving object 500 is able to move at a high speed. The presence of the obstacle within the front threshold distance may be determined based on the presence of an obstacle within a circle 510 around the moving object. At this time, the machine learning model may output the first hyperparameter as a higher value compared to other parameters, so that the moving object 500 is able to move fast. Accordingly, the second hyperparameter and the third hyperparameter may be output as lower values compared to the first hyperparameter. As a result, a speed and steering may be controlled based on the hyperparameters so that the moving object 500 is able to travel at a high speed.

According to an example, the moving object 500 may face an obstacle 520 during travelling. For example, the driving situation may be a situation in which a curvature of the driving lane, on which the moving object travels, is less than or equal to a threshold curvature, and an obstacle is present within a front threshold distance of the moving object. For example, the obstacle 520 may be included within the circle 510 as the moving object 500 travels. At this time, the machine learning model may output the second hyperparameter as a higher value than other parameters, so that the moving object 500 may avoid the obstacle 520. As a result, the speed and the steering may be controlled based on the hyperparameters so that the moving object 500 may avoid the obstacle 520 in an excellent manner.

However, the output of the machine learning model according to the driving situation described above is for convenience of description, and it will be understood after an understanding of the present disclosure that the output may be differently performed according to the training of the machine learning model.

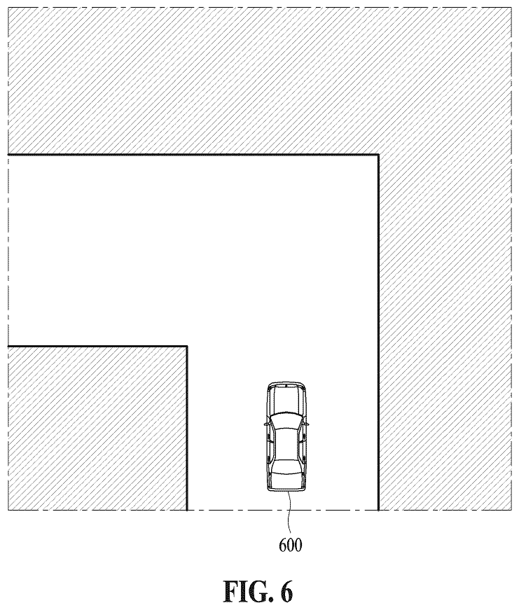

FIG. 6 shows a moving object 600 traveling on a curved road. It is assumed that the moving object 600 includes a machine learning model that has been trained to output optimal hyperparameters.

According to an example, a driving situation of FIG. 6 may be a situation in which a curvature of a driving lane, on which the moving object 600 travels, exceeds a threshold curvature. The situation in which the curvature of the driving lane, on which the moving object 600 travels, exceeds the threshold curvature may be the same as a case where an obstacle is present within a front threshold distance of the moving object. At this time, the machine learning model may output the second hyperparameter as a higher value than other hyperparameters, so that the moving object 600 may avoid the curved road (e.g., an obstacle) in an excellent manner. Accordingly, the first hyperparameter and the third hyperparameter may be output as lower values than the second hyperparameter. As a result, the moving object 600 may control the speed and the steering based on the hyperparameters so that the moving object 600 may travel the curved road in an excellent manner.

According to an example, the second hyperparameter may be determined to be greater, as a density of obstacles increases with respect to an empty space around a driving lane, on which the moving object 600 travels. The obstacle herein may include an undrivable area (e.g., sidewalk) of the moving object 600 as well as objects such as other vehicles, pedestrians, and walls. The density may be determined based on various criteria. When the density of the obstacles increases with respect to the empty space around the driving lane, on which the moving object 600 travels, the moving object 600 may avoid the obstacle in a more excellent manner. Therefore, the second hyperparameter may be determined to be greater, as the density of obstacles increases with respect to the empty space around the driving lane, on which the moving object 600 travels.

However, the output of the machine learning model according to the driving situation described above is for convenience of description, and it will be understood after an understanding of the present disclosure that the output may be differently performed according to the training of the machine learning model.

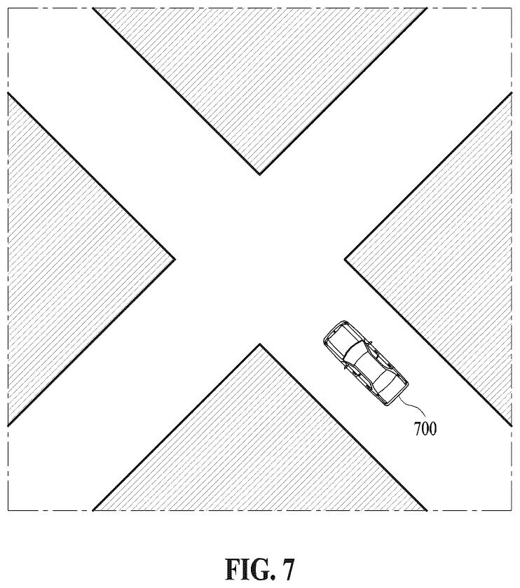

FIG. 7 shows a moving object 700 traveling on a branching road. It is assumed that the moving object 700 includes a machine learning model that has been trained to output optimal hyperparameters.

A driving situation of FIG. 7 may be a situation in which one of branching roads is to be selected according to a global path guiding the moving object 700 to a destination. At this time, the machine learning model may output the third hyperparameter as a higher value than other hyperparameters, to follow the global path guiding the moving object 700 to the destination. Accordingly, the first hyperparameter and the second hyperparameter may be output as a lower value compared to the third hyperparameter. As a result, the speed and the steering may be controlled based on the hyperparameters so that the moving object 700 follows the global path.

According to an example, the driving situation may be a situation where the global path and the obstacle conflict with each other. For example, the driving situation may be a situation where a right turn needs to be made according to the global path, but an obstacle is present on a right-turn lane. Since the safe driving is most important in the autonomous driving, avoiding an obstacle may be the most important. Therefore, a value of the second hyperparameter output by the machine learning model may be higher than a value of the third hyperparameter.

However, the output of the machine learning model according to the driving situation described above is for convenience of description, and it will be understood after an understanding of the present disclosure that the output may be differently performed according to the training of the machine learning model.

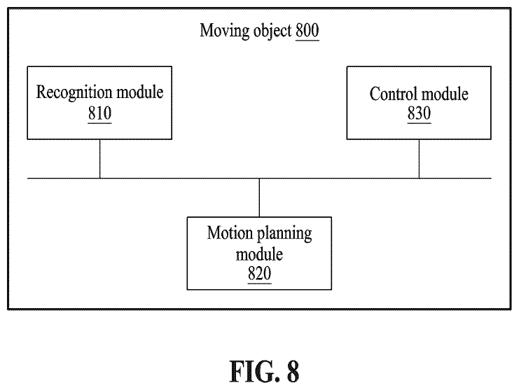

FIG. 8 illustrates an example of a moving object.

FIG. 8 shows a moving object 800 (e.g., a vehicle, a mobile robot, and/or a drone) including a recognition module 810, a motion planning module 820, and a control module 830. It will be understood after an understanding of the present disclosure that an operation of each module shown in FIG. 8 may be performed by one or more components included in the electronic device 100 shown in FIG. 1. For example, the operation of each module described hereinafter may be performed by the processor 110 of FIG. 1. For example, the moving object 800 may be or include the electronic device 100 of FIG. 1, and the processor 110 of FIG. 1 may include the recognition module 810, the motion planning module 820, and the control module 830.

The recognition module 810 may generate data related to a driving situation including an occupancy grid map, positioning information, and a global plan. The occupancy grid map may be represented two dimensionally, and each grid may be classified as an obstacle or a non-obstacle. The positioning information may indicate (x, y, yaw) information with respect to an origin of the global map based on a rear wheel of a vehicle. The global path may include a waypoint from a starting point to a destination and/or information on which next node the moving object is to travel to from a target node (e.g., an intersection or a corner portion).

The motion planning module 820 may generate a plurality of trajectories for the driving situation of the moving object based on a current speed and/or steering of the moving object 800. The motion planning module 820 may select candidate trajectories based on whether an obstacle is present, among the plurality of trajectories.

The motion planning module 820 may receive the data related to the driving situation from the recognition module 810. The motion planning module 820 may input the data related to the driving situation to a machine learning model trained to output hyperparameters related to the driving. The motion planning module 820 may preprocess the data related to the driving situation in 2D format to input the data to the machine learning model. The machine learning model may output suitable hyperparameters according to the input data related to the driving situation. For example, the hyperparameters suitable for the driving situation in which the moving object 800 currently travels may be obtained. Therefore, when the driving situation in which the moving object 800 travels is changed, the hyperparameters may be changed. For example, the hyperparameters may vary according to the driving of the moving object 800.

The machine learning model may select a target trajectory among candidate trajectories using the output hyperparameters. For example, the motion planning module 820 may select the target trajectory by inputting the output hyperparameters to a motion planning algorithm. Also, the motion planning algorithm may output a target speed and a target steering to follow the target trajectory.

The control module 830 may control the speed and the steering of the moving object 800 to follow the target speed and the target steering. The moving object may travel according to the controlled speed and steering. Accordingly, as the hyperparameters vary according to the driving situation, the moving object may stably travel.

The electronic devices, processors, memories, sensors, moving objects, recognition modules, motion planning modules, control modules, electronic device 100, processor 110, memory 120, sensor 130, moving object 800, recognition module 810, motion planning module 820, and control module 830 described herein, including descriptions with respect to respect to FIGS. 1-8, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-8 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RW, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating a plurality of trajectories for a driving situation of the moving object based on either one or both of a speed and a steering of the moving object;
selecting candidate trajectories based on a presence of an obstacle among the plurality of trajectories;
outputting hyperparameters related to driving of the moving object by inputting data related to the driving situation to a machine learning model;
selecting a target trajectory from the candidate trajectories based on the hyperparameters; and
controlling the steering and the speed such that the moving object moves along the target trajectory,
wherein the hyperparameters comprise a first hyperparameter for the speed of the moving object, a second hyperparameter for a degree to which the moving object is able to avoid an obstacle, and a third hyperparameter for a global path to a destination, and
wherein the hyperparameters vary while the moving object travels.

2. The method of claim 1, wherein the selecting of the candidate trajectories comprises selecting the candidate trajectories using remaining trajectories excluding trajectories in which the presence of an obstacle is determined within a threshold radius around the moving object, from the plurality of trajectories.

3. The method of claim 1, wherein the selecting of the target trajectory from the candidate trajectories comprises determining a score for each of the candidate trajectories using the hyperparameters, and selecting a candidate trajectory having a highest score as the target trajectory.

4. The method of claim 1, wherein the machine learning model is a model trained through reinforcement training according to a reward determined based on a first factor for the speed of the moving object, a second factor for a degree to which the moving object is able to avoid an obstacle, and a third factor for a distance between the moving object and the destination.

5. The method of claim 1, wherein, in response to the driving situation being a driving situation in which an obstacle is not present within a front threshold distance of the moving object and a curvature of a driving lane, on which the moving object travels, being within a threshold curvature, the first hyperparameter is determined to be greatest among the hyperparameters.

6. The method of claim 1, wherein, in response to the driving situation being a driving situation in which an obstacle is present within a front threshold distance of the moving object and a curvature of a driving lane, on which the moving object travels, exceeding a threshold curvature, the second hyperparameter is determined to be greatest among the hyperparameters.

7. The method of claim 1, wherein, in response to the driving situation being a situation in which the moving object travels on a driving lane comprising two or more branches, the third hyperparameter is determined to be greatest among the hyperparameters.

8. The method of claim 1, wherein, in response to a density of obstacles increasing with respect to an empty space around a driving lane, on which the moving object travels, the second hyperparameter is determined to increase.

9. A non-transitory computer-readable storage medium storing instructions that, when executed by one or more processors, configure the one or more processors to perform the method of claim 1.

10. A processor-implemented method comprising:
selecting candidate trajectories based on a presence of an obstacle among a plurality of trajectories generated for a driving situation of the moving object based on either one or both of a speed and a steering of the moving object;
outputting hyperparameters related to driving of the moving object by inputting data related to the driving situation to a machine learning model;
selecting a target trajectory from the candidate trajectories based on the hyperparameters; and
controlling the steering and the speed such that the moving object moves along the target trajectory,
wherein the machine learning model is a model trained through reinforcement training according to a reward determined based on a first factor for the speed of the moving object, a second factor for a degree to which the moving object is able to avoid an obstacle, and a third factor for a distance between the moving object and the destination, and
wherein the hyperparameters vary while the moving object travels.

11. The method of claim 10, wherein the hyperparameters comprise a first hyperparameter for the speed of the moving object, a second hyperparameter for the degree to which the moving object is able to avoid an obstacle, and a third hyperparameter for a global path to a destination.

12. An electronic device comprising:
one or more processors configured to:
generate a plurality of trajectories for a driving situation of a moving object based on either one or both of a speed and a steering of the moving object;
select candidate trajectories based on a presence of an obstacle among the plurality of trajectories;
output hyperparameters related to driving of the moving object by inputting data related to the driving situation to a machine learning model;
select a target trajectory from the candidate trajectories based on the hyperparameters; and
control the steering and the speed such that the moving object moves along the target trajectory, and
wherein the hyperparameters comprise a first hyperparameter for the speed of the moving object, a second hyperparameter for a degree to which the moving object is able to avoid an obstacle, and a third hyperparameter for a global path to a destination, and
wherein the hyperparameters vary while the moving object travels.

13. The electronic device of claim 12, wherein, for the selecting of the candidate trajectories, the one or more processors are configured to select the candidate trajectories using remaining trajectories excluding trajectories in which the presence of an obstacle is determined within a threshold radius around the moving object, from the plurality of trajectories.

14. The electronic device of claim 12, wherein, for the selecting of the target trajectory, the one or more processors are configured to determine a score for each of the candidate trajectories using the hyperparameters, and select a candidate trajectory having a highest score as the target trajectory.

15. The electronic device of claim 12, wherein the machine learning model is a model trained through reinforcement training according to a reward determined based on a first factor for the speed of the moving object, a second factor for a degree to which the moving object is able to avoid an obstacle, and a third factor for a distance between the moving object and the destination.

16. The electronic device of claim 12, wherein, in response to the driving situation being a driving situation in which an obstacle is not present within a front threshold distance of the moving object and a curvature of a driving lane, on which the moving object travels, being within a threshold curvature, the first hyperparameter is determined to be greatest among the hyperparameters.

17. The electronic device of claim 12, wherein, in response to the driving situation being a driving situation in which an obstacle is present within a front threshold distance of the moving object and a curvature of a driving lane, on which the moving object travels, exceeding a threshold curvature, the second hyperparameter is determined to be greatest among the hyperparameters.

18. The electronic device of claim 12, wherein, in response to the driving situation being a situation in which the moving object travels on a driving lane comprising two or more branches, the third hyperparameter is determined to be greatest among the hyperparameters.

19. The electronic device of claim 12, wherein, in response to a density of obstacles increasing with respect to an empty space around a driving lane, on which the moving object travels, the second hyperparameter is determined to increase.

20. A processor-implemented method comprising:
selecting candidate trajectories based on a presence of an obstacle among a plurality of trajectories generated for a driving situation of a moving object based on either one or both of a speed and a steering of the moving object;
using a machine learning model, adjusting hyperparameters based on whether the obstacle is present within a front threshold distance of the moving object and whether a curvature of a path on which the moving object travels is within a threshold curvature; and
determining a score for each of the candidate trajectories using the hyperparameters; and
determining a target trajectory by selecting a candidate trajectory having a highest score among the scores.
